(19) United States
(12) Patent Application Publication
(10) Pub. No.: US 2024/0239985 A1
(43) Pub. Date: Jul. 18, 2024

(54) METHOD FOR RECYCLING POLYMER COMPOSITE CONTAINING POLYURETHANE WASTE AND POLYETHYLENE TEREPHTHALATE WASTE

(71) Applicant: Yu-Ting CHEN, Zhudong Township (TW)

(72) Inventor: Yu-Ting CHEN, Zhudong Township (TW)

(21) Appl. No.: 18/482,562

(22) Filed: Oct. 6, 2023

(30) Foreign Application Priority Data
Jan. 13, 2023 (TW) 112101517

(51) Int. Cl. C08J 11/10; B29B 17/04

(52) U.S. Cl. CPC C08J 11/10; B29B 17/04; B29B 2017/001; C08J 2375/04; C08J 2467/02

(57) ABSTRACT

A method for recycling a polymer composite containing polyurethane waste and polyethylene terephthalate waste includes the steps of: (a) mixing a polymer composite and a first preheated glycolysis agent to obtain a premix, the polymer composite containing polyurethane waste and polyethylene terephthalate waste; (b) heating the premix to a temperature ranging from 180° C. to 240° C. so as to obtain a liquefied premix; (c) subjecting the liquefied premix to a degradation process so as to obtain a polyol mixture; and (d) subjecting the polyol mixture and a second glycolysis agent to a heat transfer process, so as to obtain a cooled polyol mixture, and a second preheated glycolysis agent.

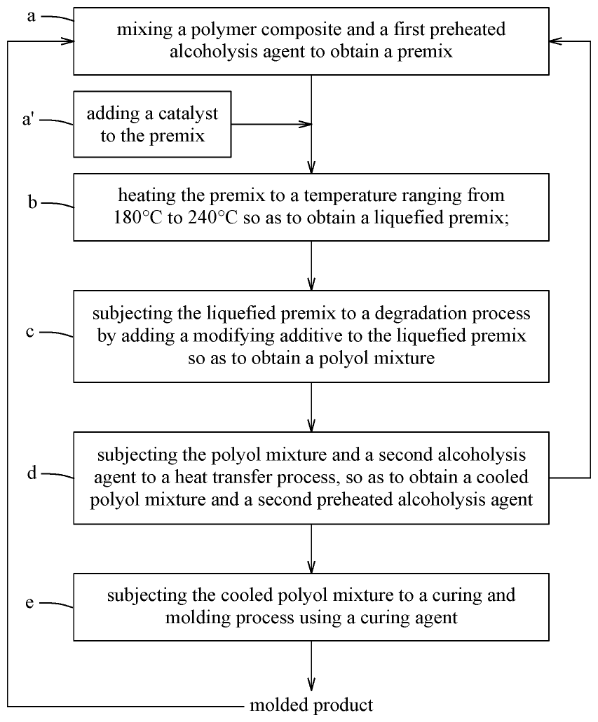

### CROSS-REFERENCE TO RELATED APPLICATION

This application claims priority to Taiwanese Invention Patent Application No. 112101517, filed on Jan. 13, 2023, and incorporated by reference herein in its entirety.

### FIELD

The present disclosure relates to a method for recycling a polymer composite, and more particularly to a method for recycling a polymer composite containing polyurethane waste and polyethylene terephthalate waste.

### BACKGROUND

Products made from polymer composites generally contain various types of organic polymeric materials such as acrylonitrile-butadiene-styrene copolymer, ethylene-vinyl acetate copolymer, polypropylene, polyvinyl chloride, polystyrene, natural rubber, polyurethane, polyester, polycarbonate, polyamide, cotton, leather, wood, etc., and also contain inorganic materials such as metal, glass, etc., causing the waste recycling process of such products, after use of the same, to be rather complex, energy-consuming, and is accompanied with problems such as slow regeneration, easily produces odors, etc. Therefore, products made of polymer composites are often treated as garbage, which are subjected to incineration or landfill, and are difficult to be recycled. Among the aforesaid organic polymeric materials, polyurethane is widely used for making foams, films, coatings, shoe components, elastic waterproof components, and other products, while polyester such as polyethylene terephthalate is widely used for making fabric fibers, films, injection molded products, and other products.

Taiwanese Invention Patent Application Publication No. TW 202222941 A discloses a method for recycling polyurethane waste and polyethylene terephthalate waste which includes chemical glycolysis, adhesion molding, infusion filling and casting, and other processes, and design of products containing combination of polyurethane and polyethylene terephthalate, so that waste pollution and waste of resources can be greatly reduced.

Products on the market claiming to be 100% recyclable means that the raw materials used for making such products are entirely sourced from recycled waste, and not that such products can be completely recycled.

### SUMMARY

Therefore, an object of the present disclosure is to provide a method for recycling a polymer composite containing polyurethane waste and polyethylene terephthalate waste that can alleviate at least one of the drawbacks of the prior art.

According to the present disclosure, the method includes the steps of:
(a) mixing a polymer composite and a first preheated glycolysis agent to obtain a premix; the polymer composite containing polyurethane waste and polyethylene terephthalate waste;
(b) heating the premix to a temperature ranging from 180° C. to 240° C. so as to obtain a liquefied premix;
(c) subjecting the liquefied premix to a degradation process so as to obtain a polyol mixture; and
(d) subjecting the polyol mixture and a second glycolysis agent to a heat transfer process, so as to obtain a cooled polyol mixture, and a second preheated glycolysis agent.

### BRIEF DESCRIPTION OF THE DRAWINGS

Other features and advantages of the present disclosure will become apparent in the following detailed description of the embodiment(s) with reference to the accompanying drawings. It is noted that various features may not be drawn to scale.

The FIGURE is a flow diagram illustrating an embodiment of a method for recycling a polymer composite containing polyurethane waste and polyethylene terephthalate waste according to the present disclosure.

### DETAILED DESCRIPTION

Before the present disclosure is described in greater detail, it should be noted that if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

Referring to the FIGURE, an embodiment of a method for recycling a polymer composite containing polyurethane waste and polyethylene terephthalate waste according to the present disclosure includes the following steps (a) to (d).

In step (a), a polymer composite and a first preheated glycolysis agent are mixed to obtain a premix. The polymer composite contains the polyurethane waste and polyethylene terephthalate waste.

In step (b), the premix is heated to a temperature ranging from 180° C. to 240° C. so as to obtain a liquefied premix.

In step (c), the liquefied premix is subjected to a degradation process so as to obtain a polyol mixture.

In step (d), the polyol mixture and a second glycolysis agent are subjected to a heat transfer process, so as to obtain a cooled polyol mixture, and a second preheated glycolysis agent.

In certain embodiments, in step (a), the first preheated glycolysis agent has a temperature ranging from 60° C. to 80° C.

In certain embodiments, in step (d), the second glycolysis agent has a temperature ranging from 0° C. to 50° C.

In certain embodiments, the cooled polyol mixture obtained in step (d) has a temperature ranging from 65° C. to 85° C.

In certain embodiments, the polymer composite is free of vinyl polymers, polycarbonates, polyamides, polysiloxanes, natural fibers, metals, and glass.

In certain embodiments, in step (a), the first preheated glycolysis agent is a preheated polyol (i.e., an organic compound containing a plurality of hydroxyl groups). The preheated polyol may be a small-molecule polyol, a polymeric polyol, or combinations thereof. In certain embodiments, the small-molecule polyol is selected from the group consisting of ethylene glycol, diethylene glycol, propylene glycol, butylene glycol, and combinations thereof. In certain embodiments, the polymeric polyol is selected from the group consisting of polyether polyol, polyester polyol, lignin, and combinations thereof. In an exemplary embodiment, the first preheated glycolysis agent is preheated diethylene glycol.

In certain embodiments, in step (d), the second glycolysis agent subjected to the heat transfer process is a polyol of the same type as the preheated polyol of step (a) as mentioned in the foregoing. It should be noted that, the second preheated glycolysis agent obtained in step (d) may be subjected back to step (a) to be mixed with the polymer composite so as to be recycled.

In certain embodiments, in step (c), the degradation process is conducted using a twin-screw extruder.

In certain embodiments, the method further includes, after performing step (a) and before performing step (b), step (a′) of adding a catalyst to the premix. In an exemplary embodiment, the catalyst is zinc acetate.

According to the present disclosure, in step (c), the polyol mixture may be obtained by adding a modifying additive to the liquefied premix to degrade the liquefied premix. In an exemplary embodiment, the modifying additive is epoxy resin.

In certain embodiments, the method further includes, after performing step (d), step (e) of subjecting the cooled polyol mixture to a curing and molding process using a curing agent. In certain embodiments, the curing and molding process is performed by casting of the curing agent and the cooled polyol mixture. In an exemplary embodiment, the curing agent is isocyanate.

The present disclosure will be described by way of the following examples. However, it should be understood that the following examples are intended solely for the purpose of illustration and should not be construed as limiting the present disclosure in practice.

### Example 1

The method of Example 1 was performed by subjecting a polymer composite to steps (a) to (e) of the embodiment of the method for recycling a polymer composite containing polyurethane waste and polyethylene terephthalate waste of the present disclosure as described in the foregoing.

In step (a), 225 kg of diethylene glycol (serving as a first preheated glycolysis agent and was purchased from Oriental Union Chemical Corporation) that was recycled and preheated to a temperature of 75° C. was mixed with 40 kg of polyurethane elastomer waste, 35 kg of polyurethane flexible foam waste and 200 kg of polyethylene terephthalate waste (together serving as a polymer composite), so as to obtain a premix.

In step (a′), which was performed after step (a), 0.085 kg of zinc acetate (serving as a catalyst, Manufacturer: King Yu Chemicals Co., Ltd.; CAS no.: 5970-45-6) was added to the premix.

In step (b), which was performed after step (a′), the premix was heated to a temperature of 220° C., so as to obtain a liquefied premix.

In step (c), which was performed after step (b), 25 kg of epoxy resin (serving as a modifying additive, Manufacturer: Epotech Composite Corporation; Catalogue no.: TFE-TF™ 01) was added to the liquefied premix in a twin-screw extruder (Manufacturer: Zenix Industrial Co., Ltd.; Model no.: ZPT-77HT) having a temperature of 220° C., followed by a mixing and extrusion conducted under a rotation speed of 400 rpm and a retention time of 40 minutes, such that the liquefied premix was subjected to a degradation process, thereby obtaining a polyol mixture having a temperature of 220° C.

In step (d), which was performed after step (c), 1000 kg of diethylene glycol (serving as a second glycolysis agent and was purchased from Oriental Union Chemical Corporation) having a temperature of 20° C. and the polyol mixture were subjected to heat transfer process, so as to obtain a preheated diethylene glycol (serving as a second preheated glycolysis agent) having a temperature of approximately 75° C. and a cooled polyol mixture having a temperature of approximately 80° C. The preheated diethylene glycol having a temperature of approximately 75° C. was then recycled to serve as the first preheated glycolysis agent in step (a).

In step (e), which was performed after step (d), isocyanate (serving as a curing agent, Manufacturer: BASF; Catalogue no.: Lupranat® M20S) was added to the cooled polyol mixture having a temperature of approximately 80° C. by infusion, such that the cooled polyol mixture was subjected to a curing and molding process in a mold, thereby obtaining a molded product. The molded product, after use, can be recycled to serve as the polymer composite in step (a).

In summary, in the method for recycling a polymer composite containing polyurethane waste and polyethylene terephthalate waste of the present disclosure, by subjecting the liquefied premix formed from a mixture of the polymer composite and the first preheated glycolysis agent to the degradation process, and then by subjecting the polyol mixture obtained from the degradation process and the second glycolysis agent to the heat transfer process such that the second preheated glycolysis agent is recycled to serve as the first preheated glycolysis agent, continuous recycling of the polymer composite containing polyurethane waste and polyethylene terephthalate waste enables products containing only polyurethane and polyethylene terephthalate to be manufactured (i.e., the polyurethane waste and polyethylene terephthalate waste of the polymer composite are completely recycled), which effectively reduces heat energy consumption, and the costs of separation, packaging and transportation, and greatly increases the production rate of the polyol mixture, thereby achieving the effects of energy-saving and carbon reduction.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for recycling a polymer composite containing polyurethane waste and polyethylene terephthalate waste, comprising the steps of:
(a) mixing a polymer composite and a first preheated glycolysis agent to obtain a premix, the polymer composite containing polyurethane waste and polyethylene terephthalate waste;
(b) heating the premix to a temperature ranging from 180° C. to 240° C. so as to obtain a liquefied premix;
(c) subjecting the liquefied premix to a degradation process so as to obtain a polyol mixture; and
(d) subjecting the polyol mixture and a second glycolysis agent to a heat transfer process, so as to obtain a cooled polyol mixture, and a second preheated glycolysis agent.

2. The method as claimed in claim 1, wherein in step (a), the first preheated glycolysis agent has a temperature ranging from 60° C. to 80° C.

3. The method as claimed in claim 1, wherein in step (d), the second glycolysis agent has a temperature ranging from 0° C. to 50° C.

4. The method as claimed in claim 1, wherein the cooled polyol mixture obtained in step (d) has a temperature ranging from 65° C. to 85° C.

5. The method as claimed in claim 1, wherein the polymer composite is free of vinyl polymers, polycarbonates, polyamides, polysiloxanes, natural fibers, metals, and glass.

6. The method as claimed in claim 1, wherein in step (a), the first preheated glycolysis agent is a preheated polyol selected from the group consisting of ethylene glycol, diethylene glycol, propylene glycol, butylene glycol, polyether polyol, polyester polyol, lignin, and combinations thereof.

7. The method as claimed in claim 1, wherein in step (d), the second glycolysis agent is a polyol selected from the group consisting of ethylene glycol, diethylene glycol, propylene glycol, butylene glycol, polyether polyol, polyester polyol, lignin, and combinations thereof.

8. The method as claimed in claim 1, wherein in step (c), the degradation process is conducted using a twin-screw extruder.

9. The method as claimed in claim 1, further comprising, after performing step (a) and before performing step (b), step (a′) of adding a catalyst to the premix.

10. The method as claimed in claim 1, wherein in step (c), the polyol mixture is obtained by adding a modifying additive to the liquefied premix to degrade the liquefied premix.

11. The method as claimed in claim 1, further comprising, after performing step (d), step (e) of subjecting the cooled polyol mixture to a curing and molding process using a curing agent.
